(19) United States
(12) Patent Application Publication
(10) Pub. No.: US 2026/0119919 A1
(43) Pub. Date: Apr. 30, 2026

(54) VERIFYING THE ROBUSTNESS OF AN AI FRAMEWORK USING CONTROLLED DELAYS

(71) Applicant: INTERNATIONAL BUSINESS MACHINES CORPORATION, ARMONK, NY (US)

(72) Inventors: ROBERT MILLER, JR., POUGHKEEPSIE, NY (US); TARIQ HANIF, LAGRANGEVILLE, NY (US)

(21) Appl. No.: 18/932,012

(22) Filed: Oct. 30, 2024

(51) Int. Cl. G06N 5/04

(52) U.S. Cl. CPC G06N 5/04

(57) ABSTRACT

Verifying the robustness of an AI framework using controlled delays, including: introducing a controlled delay into an artificial intelligence (AI) framework; and verifying inference capabilities of a model of the AI framework based on the controlled delay.

### BACKGROUND

The present disclosure relates to methods, apparatus, and products for verifying the robustness of an AI framework using controlled delays.

### SUMMARY

According to embodiments of the present disclosure, various methods, systems and products for verifying the robustness of an AI framework using controlled delays are described herein. In some aspects, verifying the robustness of an AI framework using controlled delays includes introducing a controlled delay into an artificial intelligence (AI) framework; and verifying inference capabilities of a model of the AI framework based on the controlled delay. In some aspects, a computer system may include a processor set; one or more computer-readable storage media; and program instructions stored on the one or more storage media to cause the processor set to perform operations comprising this method. In some aspects, a computer program product may include: one or more computer readable storage media; and program instructions stored on the one or more storage media to perform operations comprising this method.

### BRIEF DESCRIPTION OF THE DRAWINGS

FIG. 1 sets forth an example computing environment according to some embodiments of the present disclosure.

FIG. 2 sets forth a flowchart of an example method of verifying the robustness of an AI framework using controlled delays in accordance with some embodiments of the present disclosure.

FIG. 3 sets forth a flowchart of another example method of verifying the robustness of an AI framework using controlled delays in accordance with some embodiments of the present disclosure.

FIG. 4 sets forth a flowchart of another example method of verifying the robustness of an AI framework using controlled delays in accordance with some embodiments of the present disclosure.

FIG. 5 sets forth a flowchart of another example method of verifying the robustness of an AI framework using controlled delays in accordance with some embodiments of the present disclosure.

FIG. 6 sets forth a flowchart of another example method of verifying the robustness of an AI framework using controlled delays in accordance with some embodiments of the present disclosure.

FIG. 7 sets forth a flowchart of another example method of verifying the robustness of an AI framework using controlled delays in accordance with some embodiments of the present disclosure.

### DETAILED DESCRIPTION

Artificial intelligence (AI) frameworks may include multiple intercommunicating components that support a machine learning model in generating predictions or inferences. For example, the AI framework may include the model itself, processes or services for ingesting data for use by the model, processes or services for storing ingested data for later retrieval, processes or services for retrieving data for use by the model, and the like. The predictions and inferences provided by the AI framework may then be used in performing various functions. As an illustrative example, a machine learning model may be trained to predict how computational resources should be allocated in a system based on the predicted workload of that system. The AI framework may ingest a stream of data describing activity in the system and provide that data to the model to generate predictions for allocating system resources in substantially real-time.

A delay in any of these intercommunicating components may introduce a delay in how long it takes the model to ultimately provide a prediction or inference. Such delays may also potentially introduce errors or other performance defects in the AI framework. Accordingly, an AI framework should be resilient enough to support or handle some amount of introduced delays and still provide accurate and/or timely inferences.

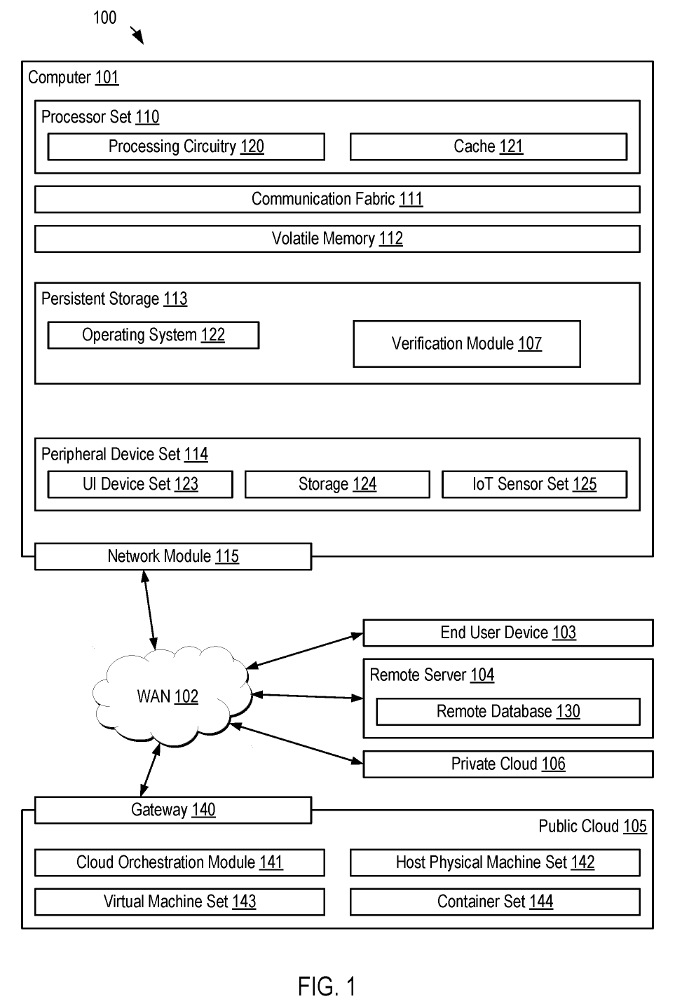

With reference now to FIG. 1, shown is an example computing environment according to aspects of the present disclosure. Computing environment 100 contains an example of an environment for the execution of at least some of the computer code involved in performing the various methods described herein, such as the verification module 107. In addition to the verification module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

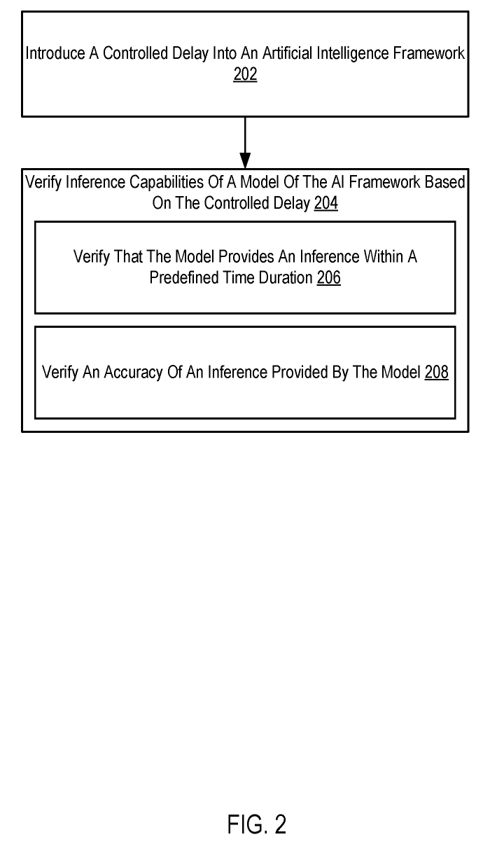

For further explanation, FIG. 2 sets forth a flowchart of an example method of verifying the robustness of an AI framework using controlled delays in accordance with some embodiments of the present disclosure. The method of FIG. 2 may be performed, for example, by the verification module 107 of FIG. 1. The method of FIG. 2 includes introducing 202 a controlled delay into an artificial intelligence (AI) framework. As described herein, an AI framework is a collection of intercommunicating processes, services, modules, and the like implemented across one or more computing devices that supports generating inferences by a machine learning model (e.g., a neural network or another machine learning model as can be appreciated). For example, an AI framework may include the model itself, processes for aggregating, ingesting, and/or retrieving data for use by the model in generating inferences, and the like. In some embodiments, the AI framework may be implemented as a data pipeline whereby data is continually ingested or accessed and the model continually (e.g., periodically or otherwise frequently) provides inferences based on this ingested or accessed data.

As the AI framework includes multiple intercommunicating components, any of these interconnecting components may experience delays in performing their particular tasks. Such delays may be due to constraints or failures in networking components, constraints related to available processing, memory, or storage resources, temporary failures or errors in processes, unavailability of data, and the like. As these intercommunicating components are dependent on each other for input and/or output data, a delay in any of these components may affect the operability and functionality of other components. This may ultimately result in an error or failure in the AI framework itself. For example, an error or failure may include the model providing an incorrect inference, a failure to provide an inference within some time threshold, and the like.

Accordingly, a controlled delay may be introduced 202 into the AI framework in order to test the resiliency of the AI framework to delays. In some embodiments, introducing 202 a controlled delay includes performing one or more actions that will cause a delay in providing output and/or receiving input by one or more of the components of the AI framework. Particularly, in some embodiments, introducing 202 a controlled delay includes performing actions that will cause a delay having a controlled, defined, or desired time duration. For example, in some embodiments, the AI framework may be configured to provide inferences within a predefined time duration after receiving some amount of input data or after some other event (e.g., ten seconds or some other duration). If the AI framework fails to provide the inference within this time duration it may be deemed that any resulting inference would be based on stale or outdated data and may be discarded. In some embodiments, the controlled delay may be introduced 202 so as to be no longer than this predefined time duration. This allows for the resiliency of the AI framework to be tested for delays up to the maximum time duration allowable for providing inferences.

As is set forth above, delays in an AI framework may be due to a variety of factors. Accordingly, introducing 202 a controlled delay into the AI framework may be performed according to a variety of approaches that will be described in further detail below in subsequent flowcharts. As examples, these approaches may include temporarily deactivating various components of the AI framework, introducing time gaps into data used by the model of the AI framework, constraining storage resources in the AI framework, restricting data available to the model of the AI framework, and other approaches.

The method of FIG. 2 also includes verifying 204 inference capabilities of a model of the AI framework based on the controlled delay. In other words, inference capabilities of the model are verified 204 after introducing 202 the controlled delay to confirm that the model continues to provide inferences despite having been affected by the controlled delay.

Verifying 204 inference capabilities of the model may be performed according to a variety of approaches. In some embodiments, verifying 204 inference capabilities of the model may include verifying 206 that the model provides an inference within a predefined time duration. The predefined time duration may correspond to the time threshold described above whereby the model is to provide inferences within some time window or any resulting inference would be discarded due to being based on stale data. In some embodiments, the predefined time duration may be relative to a time in which the controlled delay was introduced 202 or relative to another event.

In some embodiments, verifying 204 inference capabilities of the model may include verifying 208 an accuracy of an inference provided by the model. In other words, verifying 204 inference capabilities of the model may include verifying that the model can continue to provide timely and/or accurate inferences after experiencing a controlled delay. In some embodiments, the accuracy of an inference may be verified 208 by monitoring activity related to a provided inference and comparing that activity to the inference. For example, in some embodiments, an AI framework may be used to predict (e.g., as an inference) a number of initiators to start in a system based on a predicted amount of workload for that system. Accordingly, a predicted number of initiators may be compared to the number of initiators ultimately executed in the system to determine if the prediction was correct. As another example, performance metrics of the system may be measured to determine if the system, using the predicted number of initiators, experienced any performance degradation or was operating within particular parameters for acceptable performance. In some embodiments, verifying 204 inference capabilities of the model may include providing visualizations of model activity using an AI interface. These visualizations may then assist in a manual or user review of the model to determine how activity of the model was affected by the controlled delay. Other approaches may also be used to verify 204 inference capabilities of the model.

In some embodiments, introducing 202 a controlled delay into the AI framework and verifying 204 inference capabilities of the model may be repeatedly performed. For example, controlled delays may be introduced by different approaches and/or using controlled delays of different lengths. Inference capabilities of the model may then be verified for each of these different controlled delays.

Readers will appreciate that the approaches set forth above allow for the resiliency of an AI framework to withstand delays to be verified through the introduction of controlled delays. This improves the overall resiliency of the AI framework, improving system utility, performance, and the user experience.

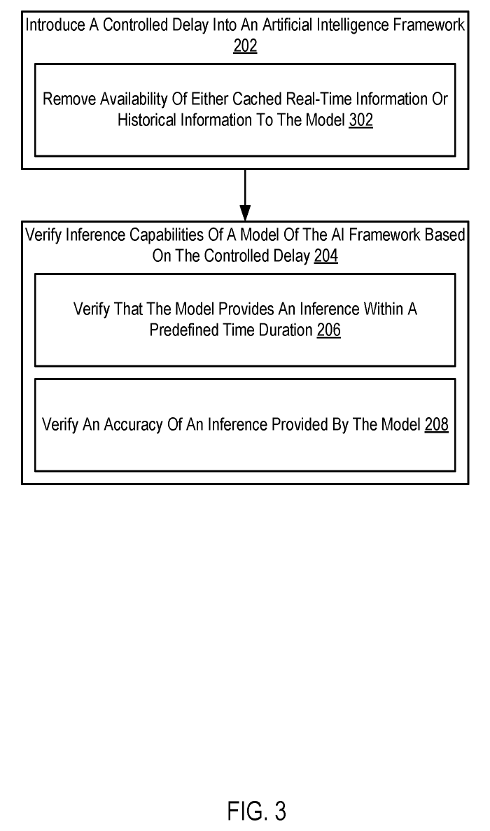

For further explanation, FIG. 3 sets forth a flowchart of an example method of verifying the robustness of an AI framework using controlled delays in accordance with some embodiments of the present disclosure. The method of FIG. 3 is similar to FIG. 2 in that the method of FIG. 3 also includes: introducing 202 a controlled delay into an artificial intelligence (AI) framework; and verifying 204 inference capabilities of a model of the AI framework based on the controlled delay, including: verifying 206 that the model provides an inference within a predefined time duration; and verifying 208 an accuracy of an inference provided by the model.

The method of FIG. 3 differs from FIG. 2 in that introducing 202 the controlled delay into the AI framework includes: removing 302 availability of either cached real-time information or historical information to the model. In some embodiments the model may generate inferences using historical data, real-time information, or combinations thereof. In some embodiments, the real-time information may include data received or ingested within some amount of time prior to a current point in time. In some embodiments, the real-time information may include data provided to or ingested into the AI framework using a stream of data and may therefore correspond to some amount of the most recently ingested or received data. This real-time information may be stored in a cache for faster access. As new data is received or ingested some amount of older real-time information may be evicted from the cache.

The historical information may correspond to some amount of time older than the cached real-time information. In some embodiments, this historical information may be ingested and stored into a database for later retrieval (e.g., for generating inferences). Accordingly, removing 302 availability of either cached real-time information or historical information to the model causes the model to generate an inference based on either cached real-time information or historical information but not both.

Removing 302 availability of either cached real-time information or historical information may be performed according to a variety of approaches. In some embodiments, a database storing historical information may be taken offline or have permissions to access the database by the AI framework modified so as to cause attempts to access the database to fail. In some embodiments, functionality of a function or service for retrieving input data for the model may be configurable so as to cause the function or service to only access either cached real-time information or historical information. In some embodiments, a process or service that ingests and/or stores real-time information (e.g., a data stream) into cache may be temporarily stopped. In some embodiments, availability of either cached real-time information or historical information may be removed for some defined amount of time so as to introduce a controlled delay of a particular amount of time. The amount of time that availability of either cached real-time information or historical information is removed may therefore vary according to the desired duration of the controlled delay. This amount of time may be determined or may vary according to particular design or engineering considerations and the particular configuration and capabilities of the AI framework itself.

Removing 302 availability of either cached real-time information or historical information may introduce a controlled delay in a variety of ways. For example, removing availability of any information may introduce errors in some functions or may cause repeated, failed attempts at accessing the information, increasing the overall amount of time required to retrieve data for use in generating an inference. As another example, where cached real-time information is unavailable, the database must be accessed so that an inference can be made using historical information. These database accesses may require more time than accessing cached data, thereby introducing a delay. As a further example, where historical information is unavailable, approximated or estimated historical information may be generated through linear interpolation, taking more time than accessing previously stored historical information and thereby introducing a delay.

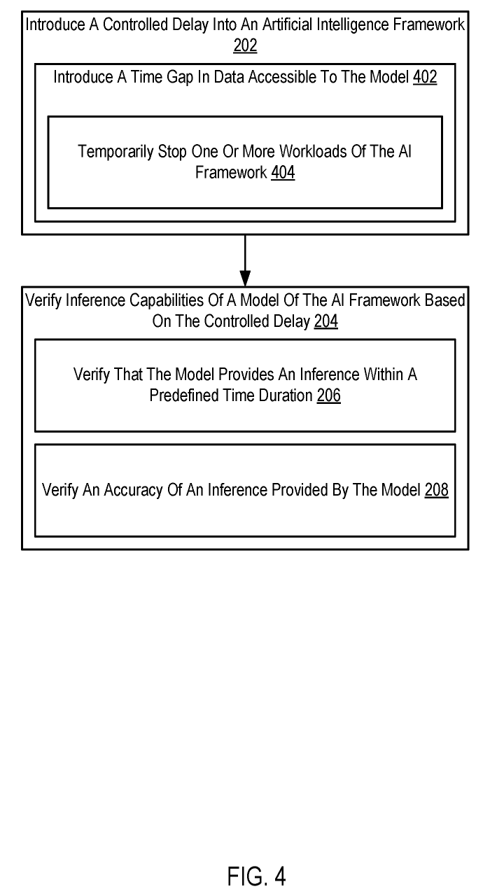

For further explanation, FIG. 4 sets forth a flowchart of an example method of verifying the robustness of an AI framework using controlled delays in accordance with some embodiments of the present disclosure. The method of FIG. 4 is similar to FIG. 2 in that the method of FIG. 4 also includes: introducing 202 a controlled delay into an artificial intelligence (AI) framework; and verifying 204 inference capabilities of a model of the AI framework based on the controlled delay, including: verifying 206 that the model provides an inference within a predefined time duration; and verifying 208 an accuracy of an inference provided by the model.

The method of FIG. 4 differs from FIG. 2 in that introducing 202 the controlled delay into the AI framework includes introducing 402 a time gap in data accessible to the model (e.g., the data used by the model in producing inferences). Various types of data usable by the model in producing inferences may include a particular time stamp at which the data was generated, ingested, and the like. A time gap in this data is a window of time for which no data is accessible to the model. This may be due to no data in the time gap existing (e.g., due to being deleted or having never been stored), due to permissions for data in this time gap preventing access by the model, and the like. The time gap may be introduced 402 into any type of input data for the model, including historical information, real-time information, other types of information, or combinations thereof.

Introducing 402 the time gap in data accessible to the model may be performed according to a variety of approaches. In some embodiments, data falling within the time period to be included in the time gap may be deleted. In some embodiments, introducing 402 the time gap in data accessible to the model may include temporarily stopping 404 one or more workloads of the AI framework. The one or more workloads may include processes or services for ingesting or storing data by or for the AI framework. For example, in some embodiments, a process may be executed to store received data into a database for later retrieval. In some embodiments, this process may be temporarily stopped so as to prevent data from being stored into the database while the process is stopped, thereby producing a time gap in the data stored into the database. As another example, a workload for processing some amount of data (e.g., by transformation, ingestion, and the like) may be temporarily stopped, thereby producing a time gap in its resulting output.

The particular duration that the one or more workloads are temporarily stopped 404 may vary according to design or engineering considerations, including the desired duration of the controlled delay and the configuration and capabilities of the AI framework itself. As an example, stopping a data ingestion process for four hours, thereby producing a four hour time gap in the ingested data, may result in a controlled delay of less than ten seconds.

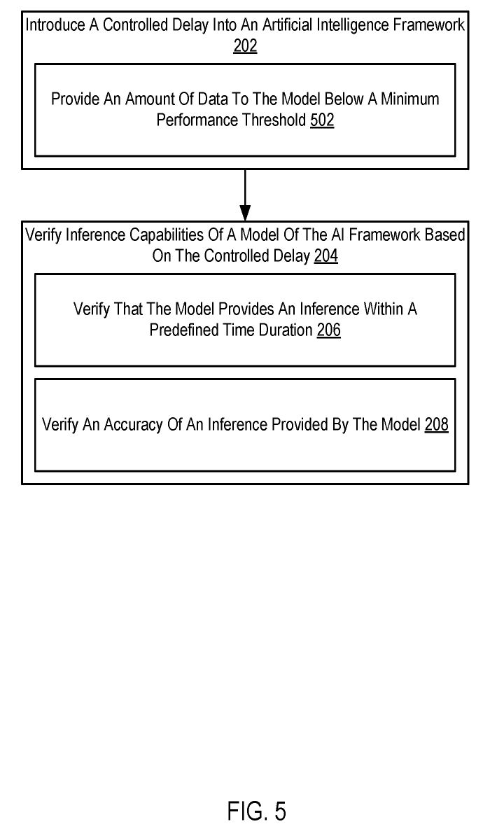

For further explanation, FIG. 5 sets forth a flowchart of an example method of verifying the robustness of an AI framework using controlled delays in accordance with some embodiments of the present disclosure. The method of FIG. 4 is similar to FIG. 2 in that the method of FIG. 4 also includes: introducing 202 a controlled delay into an artificial intelligence (AI) framework; and verifying 204 inference capabilities of a model of the AI framework based on the controlled delay, including: verifying 206 that the model provides an inference within a predefined time duration; and verifying 208 an accuracy of an inference provided by the model.

The method of FIG. 5 differs from FIG. 2 in that introducing 202 the controlled delay into the AI framework includes providing 502 an amount of data to the model below a minimum performance threshold. The data may include any data usable by the model in generating inferences, such as training data, data retrieved from a database such as historical information, and the like. The minimum performance threshold is a threshold amount of data (e.g., corresponding to some amount of time) defined according to design or engineering considerations that is desired or preferable when generating inferences. For example, where the model is preferentially trained on five days of continuous training data, the model may instead be trained using less than five days of training data. As another example, where five days of historical information is preferentially accessed from a database when generating an inference, less than five days of historical information may be accessed. This may include, for example, introducing an error when reading from the database as part of an inference request.

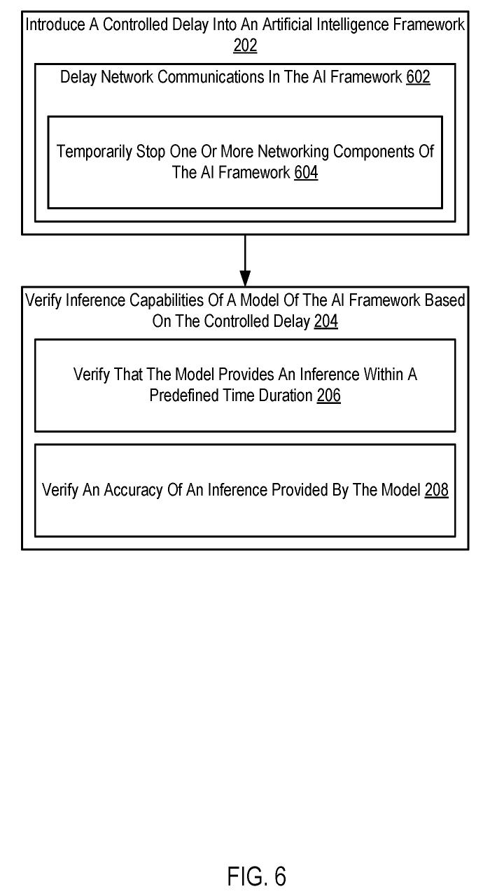

For further explanation, FIG. 6 sets forth a flowchart of an example method of verifying the robustness of an AI framework using controlled delays in accordance with some embodiments of the present disclosure. The method of FIG. 6 is similar to FIG. 2 in that the method of FIG. 6 also includes: introducing 202 a controlled delay into an artificial intelligence (AI) framework; and verifying 204 inference capabilities of a model of the AI framework based on the controlled delay, including: verifying 206 that the model provides an inference within a predefined time duration; and verifying 208 an accuracy of an inference provided by the model.

The method of FIG. 6 differs from FIG. 2 in that introducing 202 the controlled delay into the AI framework includes delaying 602 network communications in the AI framework. As is set forth above, the AI framework may include multiple intercommunicating components that may communicate using network connections such as TCP/IP connections or other network connections as can be appreciated. Accordingly, the controlled delay may be introduced 202 into the AI framework by causing delays in these communications at the network level.

In some embodiments, delaying 602 network communications in the AI framework may include restricting or throttling bandwidth or other networking resources. In some embodiments, particular components of the AI framework that enable or support networked communications may be temporarily stopped. In other words, in some embodiments, delaying 602 network communications in the AI framework may include temporarily stopping 604 one or more networking components of the AI framework. For example, in some embodiments, PAGEANT or another process or service for authenticating secure connections may be temporarily stopped 604 (e.g., for an amount of time corresponding to the desired duration of the controlled delay). As another example, the TCP/IP stack supporting the AI framework may be temporarily stopped for an amount of time corresponding to the desired duration of the controlled delay.

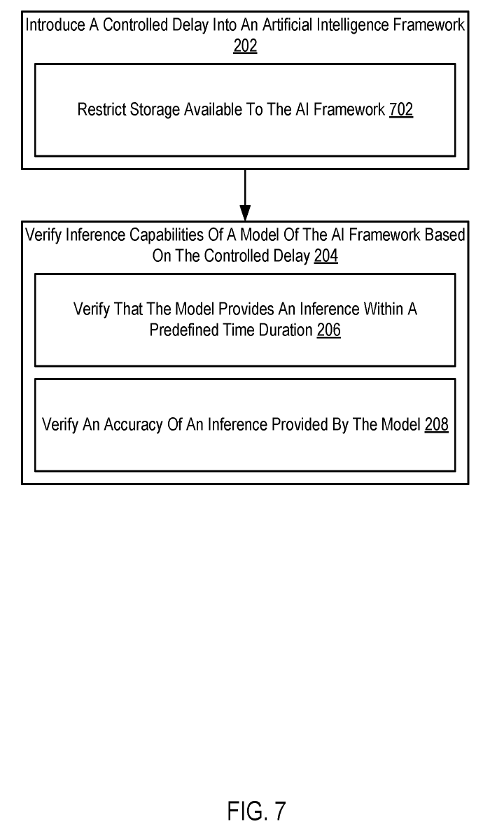

For further explanation, FIG. 7 sets forth a flowchart of an example method of verifying the robustness of an AI framework using controlled delays in accordance with some embodiments of the present disclosure. The method of FIG. 7 is similar to FIG. 2 in that the method of FIG. 7 also includes: introducing 202 a controlled delay into an artificial intelligence (AI) framework; and verifying 204 inference capabilities of a model of the AI framework based on the controlled delay, including: verifying 206 that the model provides an inference within a predefined time duration; and verifying 208 an accuracy of an inference provided by the model.

The method of FIG. 7 differs from FIG. 2 in that introducing 202 the controlled delay into the AI framework includes restricting 702 storage available to the AI framework. By introducing storage constraints to the AI framework the overall processing time for producing inferences increases, thereby introducing 202 the controlled delay. Various aspects of storage may be constrained when restricting 702 storage available to the AI framework. As an example, in some embodiments, the amount of memory reserved for data (e.g., a heap size for Java virtual machines) for some component of the AI framework may be constrained. This may lead to increased processing times for producing inferences due to increased garbage collection activity caused by the constrained amount of reserved memory. Storage may also be restricted 702 according to other approaches.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
introducing a controlled delay into an artificial intelligence (AI) framework; and
verifying inference capabilities of a model of the AI framework based on the controlled delay.

2. The computer-implemented method of claim 1, wherein introducing the controlled delay comprises removing availability of either cached real-time information or historical information to the model.

3. The computer-implemented method of claim 1, wherein introducing the controlled delay comprises introducing a time gap in data accessible to the model.

4. The computer-implemented method of claim 3, wherein introducing the time gap in the data accessible to the model comprises temporarily stopping one or more workloads of the AI framework.

5. The computer-implemented method of claim 1, wherein introducing the controlled delay comprises providing an amount of data to the model below a minimum performance threshold.

6. The computer-implemented method of claim 1, wherein introducing the controlled delay comprises delaying network communications in the AI framework.

7. The computer-implemented method of claim 6, wherein delaying network communications in the AI framework comprises temporarily stopping one or more networking components of the AI framework.

8. The computer-implemented method of claim 1, wherein introducing the controlled delay comprises restricting storage available to the AI framework.

9. The computer-implemented method of claim 1, wherein the verifying inference capabilities of the model of the AI framework comprises verifying that the model provides an inference within a predefined time duration.

10. The computer-implemented method of claim 1, wherein the verifying inference capabilities of the model of the AI framework comprises verifying an accuracy of an inference provided by the model.

11. A computer system comprising:
a processor set;
one or more computer-readable storage media; and
program instructions stored on the one or more storage media to cause the processor set to perform operations comprising:
introducing a controlled delay into an artificial intelligence (AI) framework; and
verifying inference capabilities of a model of the AI framework based on the controlled delay.

12. The computer system of claim 11, wherein introducing the controlled delay comprises removing availability of either cached real-time information or historical information to the model.

13. The computer system of claim 11, wherein introducing the controlled delay comprises introducing a time gap in data accessible to the model.

14. The computer system of claim 13, wherein introducing the time gap in the data accessible to the model comprises temporarily stopping one or more workloads of the AI framework.

15. The computer system of claim 11, wherein introducing the controlled delay comprises providing an amount of data to the model below a minimum performance threshold.

16. The computer system of claim 11, wherein introducing the controlled delay comprises delaying network communications in the AI framework.

17. The computer system of claim 16, wherein delaying network communications in the AI framework comprises temporarily stopping one or more networking components of the AI framework.

18. The computer system of claim 11, wherein the verifying inference capabilities of the model of the AI framework comprises verifying that the model provides an inference within a predefined time duration.

19. The computer system of claim 11, wherein the verifying inference capabilities of the model of the AI framework comprises verifying an accuracy of an inference provided by the model.

20. A computer program product comprising:
one or more computer readable storage media; and
program instructions stored on the one or more storage media to perform operations comprising:
introducing a controlled delay into an artificial intelligence (AI) framework; and
verifying inference capabilities of a model of the AI framework based on the controlled delay.
